(19) United States
(12) Patent Application Publication
(10) Pub. No.: US 2015/0022452 A1
(43) Pub. Date: Jan. 22, 2015

(54) ELECTRONIC DEVICE WITH PROJECTOR

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: LANG-BIN ZHU, Shenzhen (CN); XIAO-PENG CHEN, Santa Clara, CA (US); JIE DONG, Shenzhen (CN); JIA-WANG WEI, Shenzhen (CN); LI-QIN DU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/261,853

(22) Filed: Apr. 25, 2014

(30) Foreign Application Priority Data
Jul. 19, 2013 (CN) 2013103035578

(51) Int. Cl. G06F 3/02; G03B 21/14

(52) U.S. Cl. CPC G06F 3/0227; G03B 21/145; G06F 3/0202; G06F 3/021
USPC 345/168; 353/119

(57) ABSTRACT

An electronic device can include a keyboard, and a projection module. The projection module can include an installation bracket and a projector engaged with the installation bracket. The installation bracket can be engaged with the keyboard. The installation bracket can rotate about a first axis relative to the keyboard, and the projector can rotate about a second axis relative to the installation bracket substantially perpendicular to the first axis.

### RELATED APPLICATIONS

This application claims priority to China Patent Application No. 201310303557.8 filed on Jul. 19, 2013 in the China Intellectual Property Office, the contents of which are hereby incorporated by reference.

### FIELD

The present disclosure relates to electronic device, and more particularly to an electronic device with a projector.

### BACKGROUND

A keyboard usually has a signal function. Before using the keyboard, the keyboard has to be connected to a host and a monitor. A projector needs to be connected the host.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of an electronic device in accordance with an embodiment.

FIG. 2 is an exploded, isometric view of a keyboard and a projection module.

FIG. 3 is a view of the projection module and a partial view of the keyboard of FIG. 2.

FIG. 4 is an assembled view of the keyboard and the projection module of FIG. 2.

### DETAILED DESCRIPTION

The disclosure is illustrated by way of example and not by way of limitation in the figures of the accompanying drawings like references indicate similar elements. It should be noted that references to “an” or “one” embodiment in this disclosure are not necessarily to the same embodiment, and such references mean at least one.

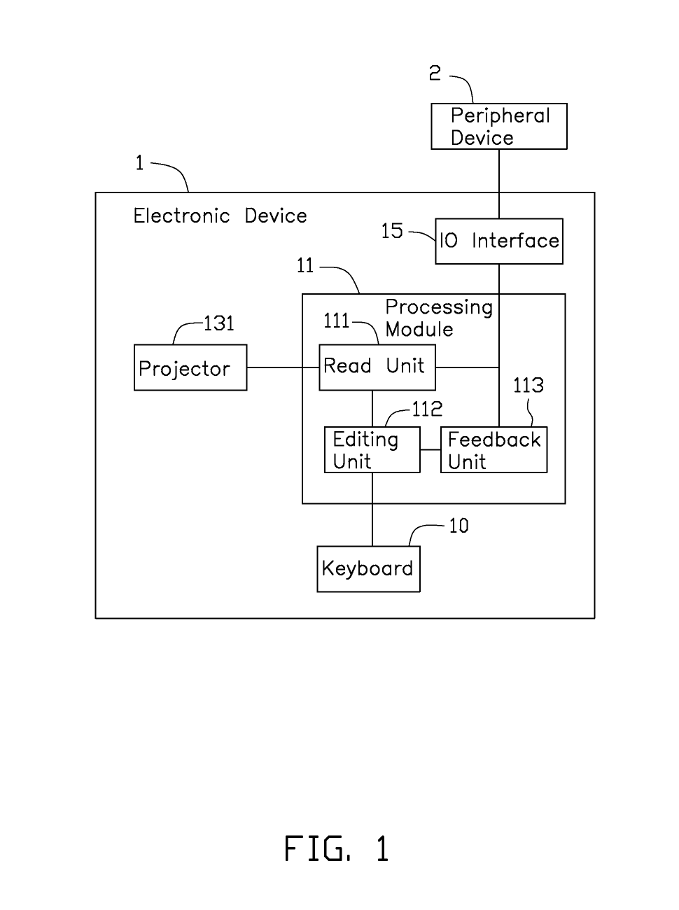

FIG. 1 illustrates an electronic device in accordance with an embodiment. The electronic device 1 includes a keyboard 10, a processing module 11, and a projection module 13 installed on the keyboard 10.

The processing module 11 can be integrated in a circuit board (not shown) and the circuit board can be accommodated in the keyboard 10. The processing module 11 can include a read unit 11, an editing unit 112 and a feedback unit 113. The read unit 111 can read data, such as videos, audios, and pictures, for example, in the peripheral device 2. The editing unit 112 can edit the data, such as delete, or copy, for example. The feedback unit 113 can store the edited data in the peripheral device 2.

The keyboard 10 can include a top plate 101, a bottom plate 102, a rear plate 103, and two side plates 104. A plurality of keys 121 can be located on the top plate 101. A limiting post 1010 can protrude from a top left of the top plate 101. The top plate 101 defines a through hole 1011 extending to the limiting post 1010.

The rear plate 103 can be substantially perpendicularly connected to the top plate 101 and the bottom plate 102. A power interface 16 can be located on the rear plate 103, for connecting a power supply (not shown) providing power to the keyboard 10. The two side plates 104 can be parallel to each other and can be substantially perpendicularly coupled to the top plate 101 and the bottom plate 102. A cutout 1021 can be cooperatively defined by the top plate 101, the bottom plate 102, the rear plate 103 and one of the two side plates 104, for receiving the projection module 13. The cutout 1021 can communicate with the through hole 1011 and can be arranged below the through hole 1011. Two input/output (IO) interfaces 15 can be located on one of the plurality of side plates 104, for connecting peripheral devices 2.

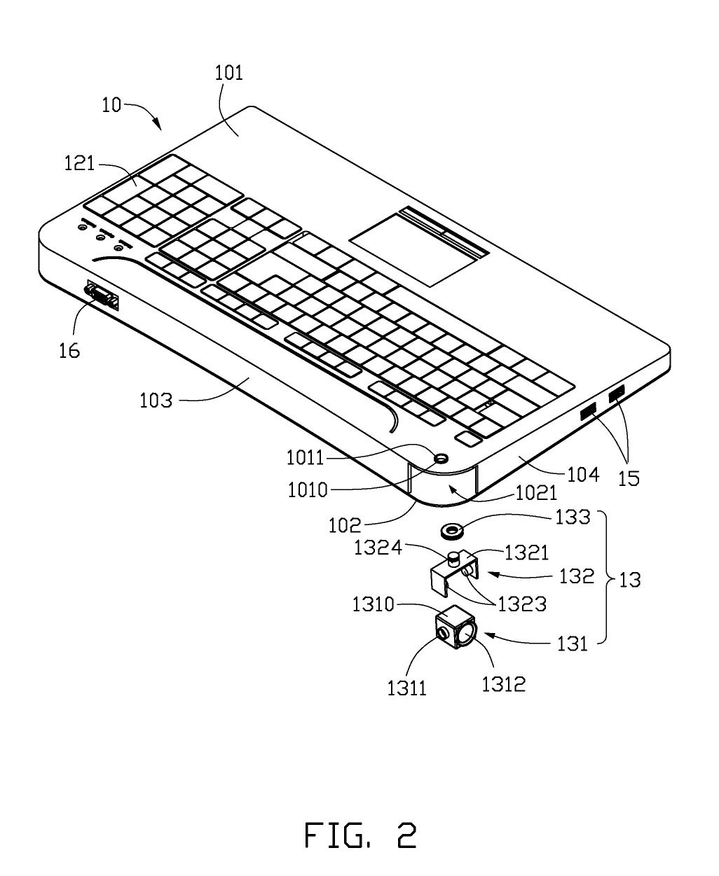

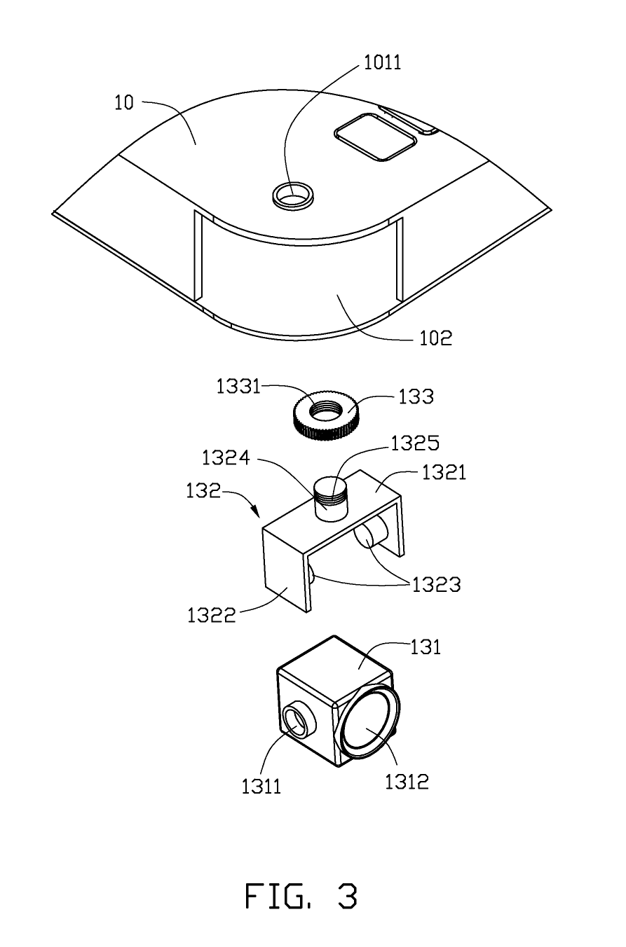

FIGS. 2 and 3 illustrate that the projection module 13 can include a projector 131, an installation bracket 132, and a latching ring 133. The projector 131 can include a body 1310, and a lens 1312 exposed from the body 1310. A pivot portion 1311 can be located on each of two opposite sides of the body 1310.

The installation bracket 132 includes a connecting piece 1321, and two clipping pieces 1322. The two clipping pieces 1322 substantially perpendicularly extend from opposite ends of the connecting piece 1321. A rotating shaft 1323 can protrude from an inner side of each of the two clipping pieces 1322. A pivot shaft 1324 can be positioned on the connecting piece 1321 and can define a plurality of outer threads 1325 in the free end of the pivot shaft 1324. The latching ring 133 can be sleeved on the limiting post 1010 and can have a plurality of inner threads 1331 corresponding to the plurality of outer threads 1325. The connecting piece 1321 can be substantially parallel to the top plate 101.

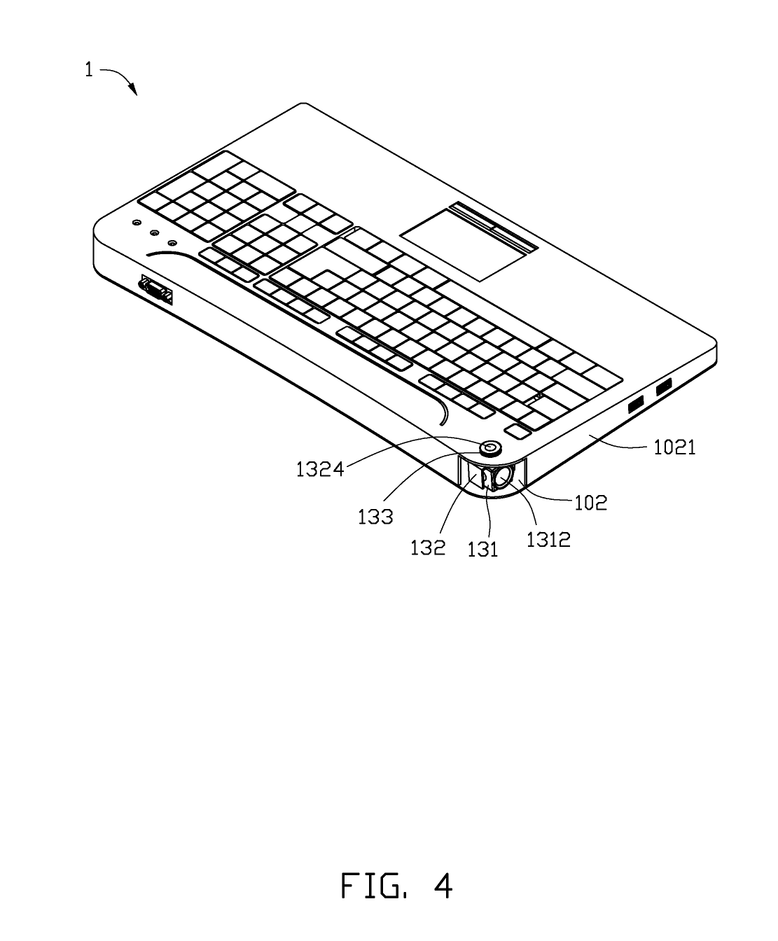

FIG. 4 illustrates that in assembly, the projector 131 can be rotatably secured to the installation bracket 132 by each rotating shaft 1323 engaged with each pivot portion 1311. The latching ring 133 can be sleeved on the limiting post 1010. The pivot shaft 1324 can extend through the through hole 1011 and can be engaged with the latching ring 133 by the plurality of outer threads 1325 engaged with the plurality of inner threads 1331. The installation bracket 132 and the projector 131 can be received in the cutout 1021 and can be located between the top plate 101 and the bottom plate 102.

In use, the installation bracket 132 can be rotatable about a first axis that can coincide with the center axis of the pivot shaft 1324, so that the projector 131 can rotate out. Further, the projector 131 can be rotatable about a second axis that can be perpendicular to the first axis and can coincide with the center axis of each of the two rotating shafts 1323, so that a horizontal angle of the projector 131 can be adjusted. The read unit 111 can read the data from the peripheral device 2 and can display the data through the projector 131.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure. The described embodiments herein are illustrative, and should not be construed as limiting the following claims.

What is claimed is:

1. An electronic device comprising:
a keyboard; and
a projection module comprising an installation bracket and a projector engaged with the installation bracket, the installation bracket being engaged with the keyboard;
wherein the installation bracket is rotatable about a first axis relative to the keyboard, the projector is rotatable about a second axis relative to the installation bracket, and the second axis is substantially perpendicular to the first axis.

2. The electronic device of claim 1, wherein the keyboard comprises a top plate, the installation bracket is engaged with the top plate, and the first axis is substantially perpendicular to the top plate.

3. The electronic device of claim 2, wherein the keyboard further comprises a bottom plate, and the installation bracket and the projector are located between the top plate and the bottom plate.

4. The electronic device of claim 2, wherein the installation bracket comprises a pivot shaft, the projection module further comprises a latching ring, the top plate defines a through hole, and the pivot shaft extends through the through hole to be engaged with the latching ring.

5. The electronic device of claim 4, wherein the pivot shaft has a center axis, and the center axis is coincided with the first axis.

6. The electronic device of claim 4, wherein a limiting post is located on the top plate, the through hole extends to the limiting post, the latching ring abuts the limiting post, and the pivot shaft is received in the limiting post and engaged with the latching ring.

7. The electronic device of claim 4, wherein the installation bracket further comprises two clipping pieces, and the projector is located between the two clipping pieces and is rotatable about the second axis.

8. The electronic device of claim 7, wherein the installation bracket further comprises two rotating shafts, the projector comprises two pivot portions, and each of the two pivot portions is engaged with each of the two rotating shafts.

9. The electronic device of claim 8, wherein each of the two rotating shaft is protruded from each of the two clipping pieces, each of the two rotating shaft has a center axis, and each center axis is substantially perpendicular to the two clipping pieces and coincided with the second axis.

10. The electronic device of claim 8, wherein the installation bracket further comprises a connecting piece, and the two clipping pieces substantially perpendicularly extend from opposite ends of the connecting piece, and the pivot shaft is located on the connecting piece.

11. An electronic device, comprising:
a keyboard connected to a peripheral device, which stores data;
a processing module adapted to connected to the peripheral device and read the data; and
a projector connected to the processing module and engaged with the keyboard;
wherein the keyboard is adapted to edit the data, and the projector is adapted to display the data and is rotatable relative to the keyboard.

12. The electronic device of claim 11, further comprising an installation bracket, wherein the installation bracket is engaged with the keyboard, the installation bracket is rotatable about a first axis relative to the keyboard, and the projector is rotatable about a second axis relative to the installation bracket substantially perpendicular to the first axis.

13. The electronic device of claim 12, wherein the keyboard defines a cutout in a corner of the keyboard, and the installation bracket and the projector are received in the corner.

14. The electronic device of claim 12, wherein the keyboard comprises a top plate, the installation bracket comprises a pivot shaft, the projection module further comprises a latching ring, the top plate defines a through hole, and the pivot shaft extends through the through hole to be engaged with the latching ring.

15. The electronic device of claim 14, wherein the pivot shaft has a center axis, and the center axis is coaxial with the first axis.

16. The electronic device of claim 14, wherein a limiting post is located on the top plate, the through hole extends to the limiting post, the latching ring abuts the limiting post, and the pivot shaft is received in the limiting post and engaged with the latching ring.

17. The electronic device of claim 14, wherein the installation bracket further comprises two clipping pieces, the projection module further comprises a projector, and the projector is engaged between the two clipping pieces and is rotatable about the second axis.

18. The electronic device of claim 17, wherein the installation bracket further comprises two rotating shafts, the projector comprises two pivot portions, and each of the two pivot portions is engaged with each of the two rotating shafts.

19. The electronic device of claim 18, wherein each of the two rotating shaft protrudes from each of the two clipping pieces, each of the two rotating shaft has a center axis, and each center axis is substantially perpendicular to the two clipping pieces and coaxial with the second axis.

20. The electronic device of claim 18, wherein the installation bracket further comprises a connecting piece, the two clipping pieces substantially perpendicularly extend from opposite ends of the connecting piece, and the pivot shaft is located on the connecting piece.
